(19) United States
(12) Patent Application Publication
(10) Pub. No.: US 2013/0268143 A1
(43) Pub. Date: Oct. 10, 2013

(54) Vehicle Intelligent Key Device, Remote Control System, and Method for Driving a Passenger Vehicle

(71) Applicants: SHENZHEN BYD AUTO R&D COMPANY LIMITED, Shenzhen (CN); BYD COMPANY LIMITED, Shenzhen (CN)

(72) Inventors: Xiaowen DU, Shenzhen (CN); Yongzeng ZHANG, Shenzhen (CN); Yilin ZHONG, Shenzhen (CN); Bo FAN, Shenzhen (CN)

(21) Appl. No.: 13/857,757

(22) Filed: Apr. 5, 2013

(30) Foreign Application Priority Data
Apr. 6, 2012 (CN) 201210099965.1

(51) Int. Cl. G06F 17/00

(52) U.S. Cl. CPC G06F 17/00
USPC 701/2

(57) ABSTRACT

A remote control system comprises: a vehicle intelligent key device, configured to send a starting signal and a control signal; a passenger vehicle, configured to receive the starting signal or the control signal, to start a remote control mode according to the starting signal, and to control an operational state of the passenger vehicle according to the control signal and to quit the remote control mode when a predetermined condition is satisfied.

### CROSS-REFERENCE TO RELATED APPLICATION

This application claims priority to and benefit of Chinese Patent Application No. 201210099965.1, filed with the State Intellectual Property Office of P.R. China on Apr. 6, 2012, the entire contents of which are incorporated herein by reference.

### FIELD

The present disclosure relates generally to a vehicular technology and, more particularly, to a vehicle intelligent key device, a remote control system for driving a vehicle, and a remote control method for driving the vehicle.

### BACKGROUND

More and more individuals and families use passenger vehicles as main transportation tools. It becomes more and more difficult to find a parking space as the number of passenger vehicles increases. For densely populated cities, parking spaces for vehicles are not only in shortage but also becoming much smaller. Therefore, it is difficult for a driver to maneuver the vehicle in or out of the parking space. It is also difficult for the driver or a passenger to get in or off the vehicle when the vehicle is parked.

There is a need to control the vehicle to park or start the vehicle from outside, so that the driver does not need to get in or get off the vehicle in a narrow parking space.

### SUMMARY

According to some embodiments, a remote control system for driving a vehicle is provided. The remote control system may comprise: a vehicle intelligent key device, configured to send a starting signal and a control signal; a vehicle, configured to receive the starting signal or the control signal, to start a remote control mode according to the starting signal, and to control an operational state of the vehicle according to the control signal and to quit the remote control mode when a predetermined condition is satisfied.

According to some alternative embodiments, a vehicle intelligent key device is provided. The vehicle intelligent key device may comprise: a starting key; a direction control key; a wireless communication module, configured to communicate with a vehicle wirelessly; and a controlling module, connected to the starting key, the direction control key and the wireless communication module, and configured to send a starting signal or a control signal to the vehicle when the starting key or the direction control key is activated.

According to still some alternative embodiments, a remote control method for driving a vehicle is provided. The remote control method may comprise: generating a starting signal and a control signal by a vehicle intelligent key device; sending the starting signal and the control signal to a vehicle; starting a remote control mode of the vehicle according to the starting signal; controlling operational state of the vehicle according to the control signal; and quitting the remote control mode when a predetermined condition is satisfied.

The above summary of the present disclosure is not intended to describe each disclosed embodiment or every implementation of the present disclosure. The figures and the detailed description which follow more particularly exemplify illustrative embodiments. Additional aspects and advantages of embodiments of present disclosure will be given in part in the following descriptions, and become apparent in part from the following descriptions, or be learned from the practice of the embodiments of the present disclosure.

### BRIEF DESCRIPTION OF THE DRAWINGS

FIG. 1 is a block diagram of a remote control system for driving a vehicle according to an embodiment of the present disclosure;

FIG. 2 is a block diagram of a remote control system in a remote starting mode according to an embodiment of the present disclosure;

FIG. 3 is a block diagram of a remote control system in a remote control mode according to an embodiment of the present disclosure;

FIG. 4 is a block diagram of a remote control system in a remote turning mode according to an embodiment of the present disclosure;

FIG. 5 is a block diagram of a vehicle intelligent key device according to an embodiment of the present disclosure;

FIG. 6 is a schematic view of a control panel of a vehicle intelligent key device according to an embodiment of the present disclosure;

FIG. 7 is a flow chart of a remote control method for driving a vehicle according to an embodiment of the present disclosure;

FIGS. 8A-8B are a flow chart of a process for controlling the vehicle to start a remote control mode according to an embodiment of the present disclosure;

FIGS. 9A-9B are a flow chart of a process for controlling the vehicle to move forward according to an embodiment of the present disclosure;

FIGS. 10A-10B are a flow chart of a process for controlling the vehicle to move backward according to an embodiment of the present disclosure;

FIG. 11 is a flow chart of a process for controlling the vehicle to turn left or right according to an embodiment of the present disclosure;

FIG. 12 is a flow chart of a process for controlling the vehicle to quit the remote control mode according to an embodiment of the present disclosure; and

FIG. 13 is a flow chart of a process for controlling the vehicle to quit the remote control mode according to another embodiment of the present disclosure.

### DETAILED DESCRIPTION

Reference will be made in detail to embodiments of the present disclosure. The embodiments described herein with reference to accompanying drawings are explanatory and illustrative, which are used to generally describe the present disclosure. The embodiments shall not be construed to limit the present disclosure. The same or similar elements and the elements having same or similar functions are denoted by like reference numerals throughout the descriptions.

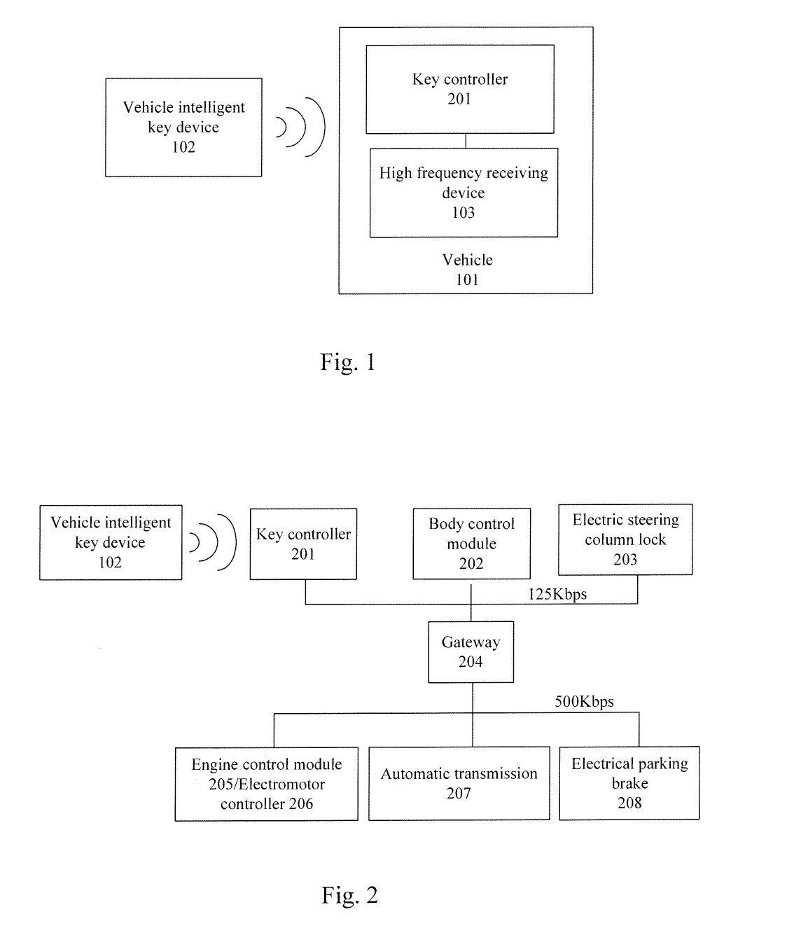

FIG. 1 is a block diagram of a remote control system 100 for driving a vehicle according to an embodiment of the present disclosure. As shown in FIG. 1, the remote control system 100 comprises a vehicle 101 and a vehicle intelligent key device 102. The vehicle intelligent key device 102 is configured to send a starting signal and a control signal to the vehicle 101. The vehicle 101 is configured to receive the starting signal and the control signal. The starting signal may cause the vehicle 101 to start a remote control mode. The control signal may control a driving state of the vehicle 101 and also control the vehicle 101 to quit the remote control mode when a predetermined condition is satisfied. Additionally, controlling the driving state of the vehicle 101 may comprise controlling at least one of a steering system, a speed control system, or a braking system of the vehicle 101.

In one embodiment of the present disclosure, the starting signal may be a high-frequency starting signal and the control signal may be a high-frequency control signal. Additionally, the vehicle 101 may further comprise a high-frequency receiving device 103 configured to receive the high-frequency starting signal and the high-frequency control signal sent from the vehicle intelligent key device 102. The high-frequency receiving device 103 may demodulate the high-frequency starting signal and the high-frequency control signal so as to obtain the starting signal and the control signal, and send the starting signal and the control signal to the key controller 201.

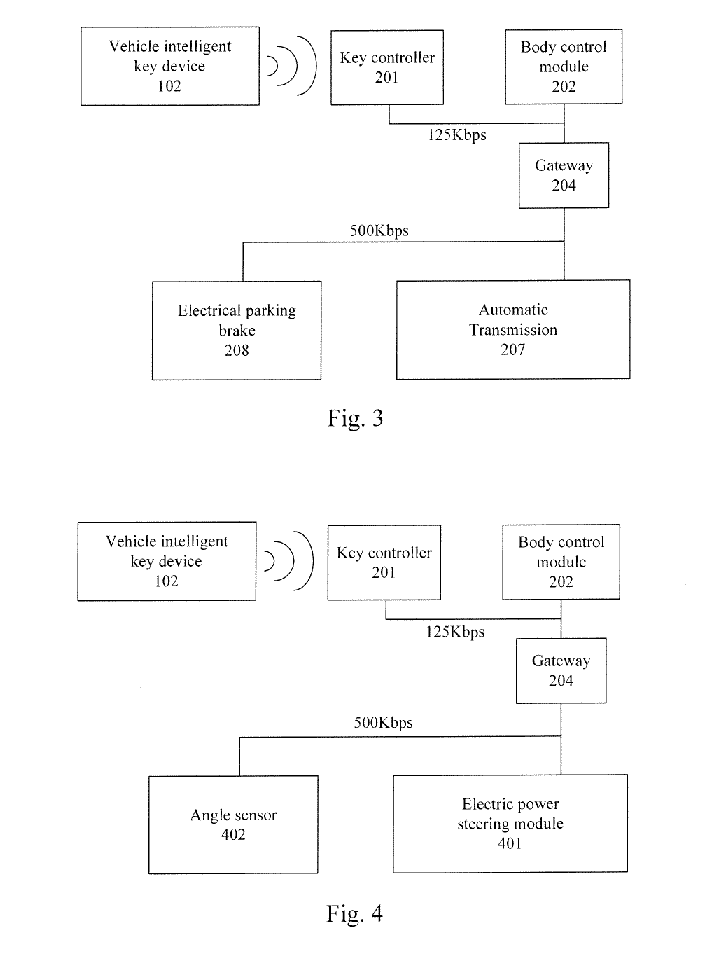

FIG. 2 is a block diagram of a remote control system 200 operating in a remote starting mode according to an embodiment of the present disclosure. According to one embodiment, the vehicle 101 is a fuel vehicle. The vehicle 101 may further comprise a key controller 201, a body control module (BCM) 202, an electric steering column lock (ECL) 203, a gateway 204, an engine control module (ECM) 205, an automatic transmission 207, and an electrical parking brake (EPB) 208. The automatic transmission 207 may be a dual clutch transmission (DCT).

According to another embodiment, the vehicle 101 may be an electric vehicle. The vehicle 101 may further comprise a key controller 201, a body control module 202, an electric steering column lock 203, a gateway 204, an electromotor controller 206, an automatic transmission 207, and an electrical parking brake 208.

The key controller 201, the body control module 202, the electric steering column lock 203, the engine control module (ECM) 205/electromotor controller 206, the automatic transmission 207, and the electrical park braking 208 are configured to communicate with one another through the gateway 204. Specifically, the key controller 201 may receive the starting signal and the control signal sent from the vehicle intelligent key device 102 and generate a remote starting signal or a remote control signal according to the starting signal and the control signal.

The body control module 202 is configured to receive the remote starting signal and the remote control signal sent from the key controller 201, and to control the vehicle 101 to power on, start the remote control mode according to the remote starting signal, and generate an unlocking signal.

The electric steering column lock 203 is configured to receive the unlocking signal sent from the body control module 202 and unlock a steering wheel of the vehicle 101 according to the unlocking signal.

The gateway 204 is configured to communicate with the key controller 201, the body control module 202, and the electric steering column lock 203 respectively. The gateway 204 is configured to provide high/low speed network communications. For example, the high speed may be 500 Kbps (bit per second), and the low speed may be 125 Kbps.

The engine control module 205 is configured to communicate with the gateway 204 and to control an engine of the vehicle 101 to start according to the remote starting signal transmitted by the gateway 204.

The electromotor controller 206 is configured to control the power system of the vehicle 101 to start according to the remote starting signal transmitted by the gateway 204.

The automatic transmission 207 is configured to communicate with the gateway 204 to receive the remote control signal. The automatic transmission 207 may control a gearbox of the vehicle 101 to switch to different gears and generate a parking control signal according to the remote control signal. Thus, the automatic transmission 207 may cause the vehicle 101 to operate at different gears.

The electrical parking brake 208 is configured to communicate with the gateway 204 and to control the vehicle 101 to park according to the parking control signal transmitted by the gateway 204.

In one embodiment of the present disclosure, as shown in FIG. 2, the key controller 201 is further configured to detect whether the vehicle intelligent key device 102 is outside the vehicle 101 after receiving the starting signal and the control signal, and to send the remote starting signal and the remote control signal to the body control module 202 when the vehicle intelligent key device 102 is outside the vehicle 101.

The body control module 202 is further configured to detect a state of the electrical parking brake 208 and the gear of the gearbox of the vehicle 101. For a fuel vehicle, when the state of the electrical parking brake 208 is “normal” and the gearbox of the vehicle 101 is at “Park” gear the engine control module 205 and the key controller 201 perform a pairing operation. If the engine control module 205 and the key controller 201 are paired, the engine control module 205 controls the engine to start. For an electric vehicle, when the state of the electrical parking brake 208 is “normal” and the gearbox of the vehicle is at the “Park” gear, the electromotor controller 206 and the key controller 201 perform the pairing operation. If the electromotor 206 and the key controller are paired, the electromotor 206 controls the power system of the vehicle 101 to start. After the engine/power system is started, the starting of the remote control mode of the vehicle 101 is completed. The vehicle 101 enters the remote control mode.

In some embodiments of the present disclosure, the body control module 202 is configured to control the engine and/or the power system to quit the remote control mode if any one of the following conditions is satisfied:

1) no remote control signal is detected by the body control module 202 during a first predetermined time period;

2) no remote control mode signal indicating the vehicle 101 is in the remote control mode is detected by the body control module 202 during a second predetermined time period;

3) a quitting remote control mode signal is detected by the body control module 202;

4) the body control module 202 detects that a vehicle door is open;

5) the body control module 202 detects that a brake pedal or an accelerator pedal is pressed down;

6) a vehicle speed is detected to be higher than a predetermined threshold speed or the vehicle speed is not detected by the body control module 202; or

7) the body control module 202 receives a remote unlocking signal or a micro switch unlocking signal sent from the key controller 201.

In one embodiment of the present disclosure, the first predetermined time period may be 10 minutes, the second predetermined time period may be 2 seconds, the predetermined threshold speed may be 2 km/h. The values of the first predetermined time period, the second predetermined time period, and the predetermined threshold speed may be different from those described above, depending on driving habits of different users.

In some embodiments of the present disclosure, the automatic transmission 207 may be configured to send an engaging signal the electrical parking brake 208 for engaging a parking cable and to set the gearbox to the “Park” gear when the engine and/or the power system quits the remote control mode.

In one example of the present disclosure, the remote control signal may be any one of a remote forward signal, a remote backward signal, or a remote turning signal. The remote forward signal is configured to control the vehicle 101 to move forward, the remote backward signal is configured to control the vehicle 101 to reverse, and the remote turning signal is configured to control the vehicle 101 to turn left or right.

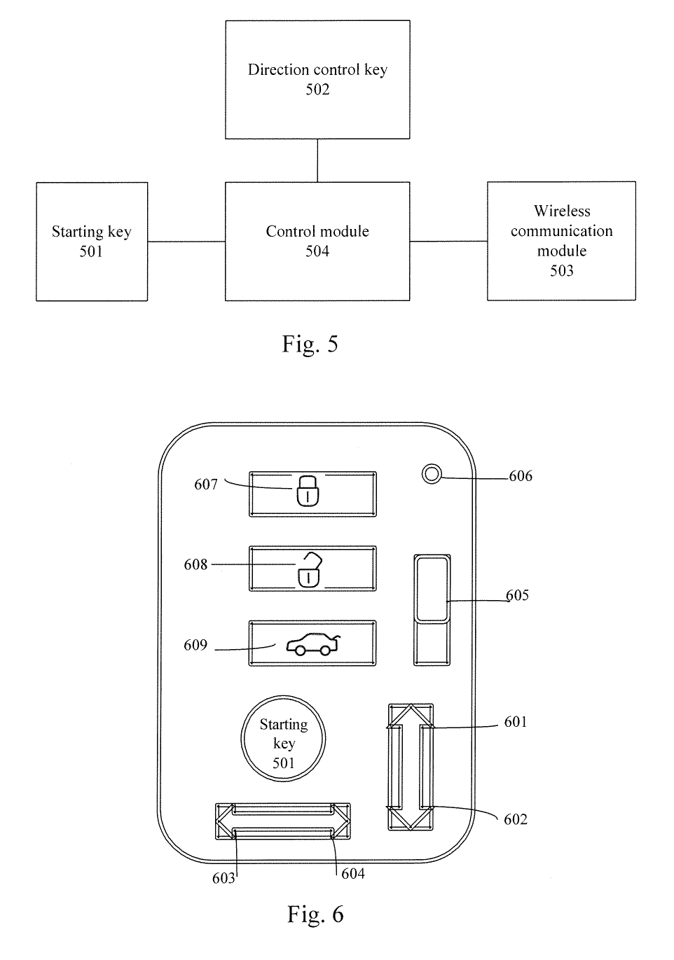

Specifically, in one example of the present disclosure, as shown in FIG. 3, when the automatic transmission 207 receives a remote forward signal and detects that the engine and/or the power system are in the remote control mode, the automatic transmission 207 may control the electrical parking brake 208 to disengage the parking cable and return a state of the parking cable. The automatic transmission 207 may also set the gearbox to the “Drive” gear. Accordingly, the vehicle 101 may move forward at a speed lower than the predetermined vehicle speed (e.g., 2 km/h).

In another embodiment of the present disclosure, when the automatic transmission 207 receives a remote forward signal and detects that the engine and/or the power system are in the remote control mode, the automatic transmission 207 may control the electrical parking brake 208 to disengage the parking cable and to return a status of the parking cable. The automatic transmission 207 may also set the gearbox to the “Reverse” gear. Accordingly, the vehicle 101 may move backward at a speed lower than the predetermined vehicle speed (e.g., 2 km/h).

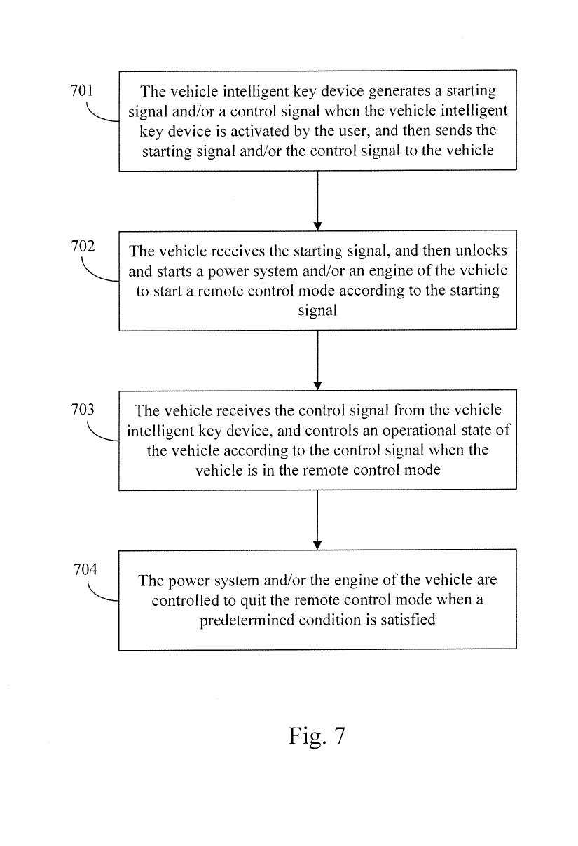

FIG. 4 is a block diagram of an exemplary embodiment of a remote control system 400 operating in a remote turning mode. As shown in FIG. 4, the vehicle may further comprise an electric power steering module (EPS) 401 and an angle sensor 402.

The electric power steering module (EPS) 401 is configured to receive the remote turning signal sent from the key controller 201 and to control the steering wheel of the vehicle 101 to rotate when the engine and/or the power system are in the remote control mode. The angle sensor 402 is configured to detect the rotation angle of the steering wheel and to return the rotation angle to the electric power steering module 401. Then the electric power steering module 401 may control a steering column of the vehicle 101 to turn left or right at a certain speed.

The remote control system described herein allows a user outside the vehicle to control the vehicle to move forward or backward at a speed lower than the predetermined vehicle speed (e.g., 2 km/h), or control the vehicle to turn left or right within a visual range (e.g., 10 meters). The operation of the remote control system is simple and easy. Therefore, it is very convenient for a user to park or move a vehicle in a narrow space. In addition, the user may control the vehicle to quit the remote control mode when necessary and, thus, ensure safety.

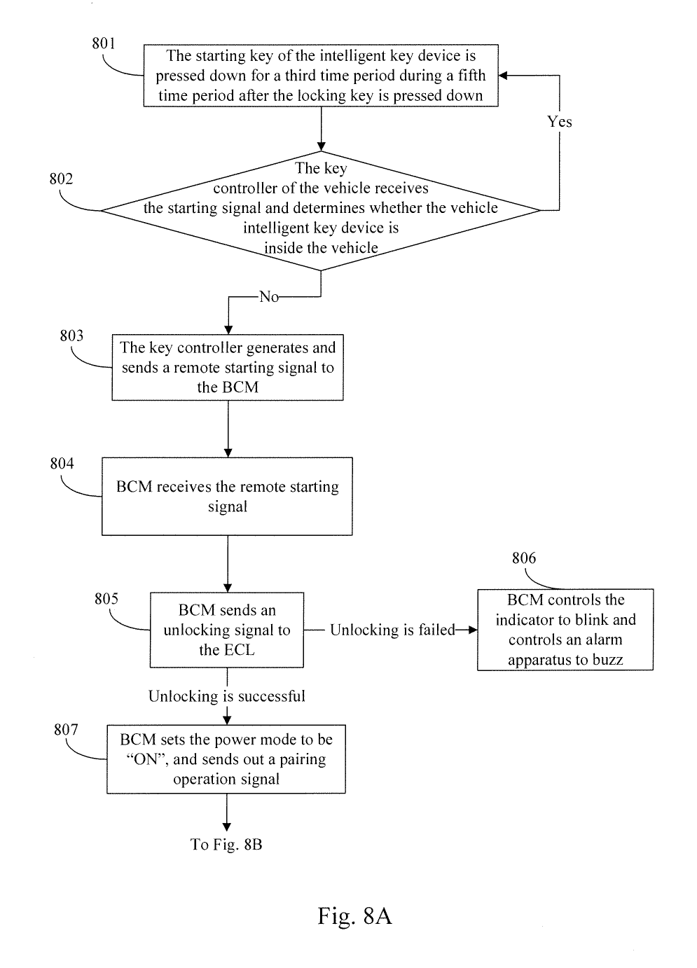

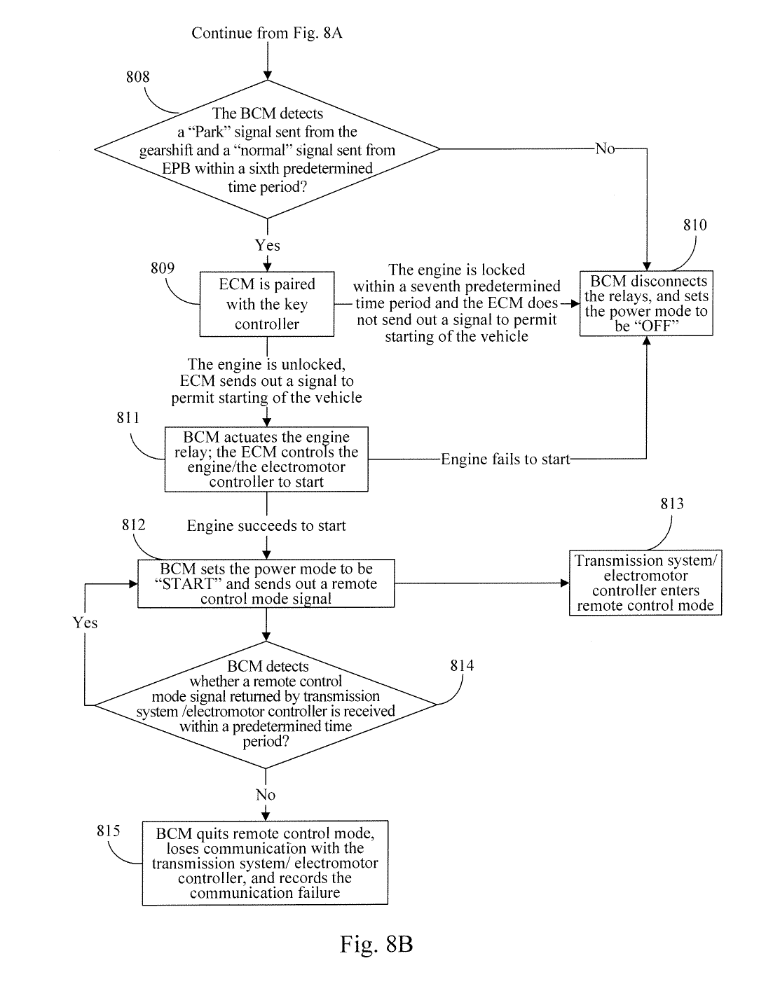

Referring to FIGS. 5 and 6, the vehicle intelligent key device 102 will be described in detail according to embodiments of the present disclosure.

FIG. 5 is a block diagram of the vehicle intelligent key device 102 according to an embodiment. As shown in FIG. 5, the vehicle intelligent key device 102 may comprise a starting key 501, a direction control key 502, a wireless communication module 503, and a control module 504. The wireless communication module 503 is configured to communicate with the vehicle 101 wirelessly. The control module 504 is electronically connected to the starting key 501, the direction control key 502, and the wireless communication module 503, and configured to send a starting signal or a control signal to the vehicle 101 when the starting key 501 or the direction control key 502 is activated.

A user may activate the starting key 501 by, for example, pressing and holding the starting key 501 for a time period greater than a third predetermined time period. The vehicle intelligent key device 102 may modulate relevant information and send a first high-frequency starting signal incorporating the modulated information. A high-frequency receiving device of the vehicle 101 may receive the first high-frequency starting signal and then send a starting signal to the key controller 201 of the vehicle 101 after demodulating the first high-frequency starting signal. The key controller 201 authenticates the starting signal, and then sends a “start” message to cause the vehicle 101 to start. In one embodiment, the third predetermined time period may be 2 seconds or may be any other values.

According to another embodiment, when the starting key 501 is pressed and held for a time period less than the third predetermined time period, the vehicle intelligent key device 102 may modulate relevant information and send a second high-frequency starting signal. Then the high-frequency receiving device of the vehicle 101 may receive the second high frequency starting signal and send an off signal to the key controller 201 of the vehicle after demodulating the second high-frequency starting signal. The key controller 201 authenticates the off signal, and then sends an “off” message to cause the vehicle to be turned off.

FIG. 6 is a schematic view of a control panel 600 of a vehicle intelligent key device 102 according to an embodiment of the present disclosure. As shown in FIG. 6, the direction control key 502 may comprise at least one of a left turning key 603, a right turning key 604, a forward key 601, and a backward key 602.

In one embodiment of the present disclosure, when the user activates the forward key 601 by, for example, pressing and holding the forward key 601, the vehicle intelligent key device 102 may modulate relevant information and send a high-frequency forward signal. Then, the high-frequency receiving device 103 of the vehicle 101 may receive the high-frequency forward signal and send a forward signal to the key controller 201 of the vehicle 101 after demodulating the high-frequency forward signal. The key controller 201 authenticates the forward signal, and then sends out a “Drive” message to cause the vehicle to move forward at a low speed. In one embodiment of the present disclosure, the vehicle may move forward at a speed lower than 2 km/h. The user may release the forward key 601 to cause the vehicle to stop.

In one embodiment of the present disclosure, the driver may activate the backward key 602 by, for example, pressing and holding the backward key 602. The vehicle intelligent key device 102 may modulate relevant information and send a high-frequency backward signal. Then the high-frequency receiving device 103 of the vehicle 101 may receive the high-frequency backward signal and send a backward signal to the key controller 201 of the vehicle 101 after demodulating the high-frequency backward signal. The key controller 201 authenticates the backward signal and then sends a “Reverse” message to cause the vehicle to move backward at a low speed. In one embodiment of the present disclosure, the vehicle may move backward at a speed lower than 2 km/h. The user may release the backward key 602 to cause the vehicle to stop.

In one embodiment of the present disclosure, when the user activates the left turning key 603 by, for example, pressing and holding the left turning key 603, the vehicle intelligent key device 102 may modulate relevant information and send a high-frequency left turning signal. Then the high-frequency receiving device 103 of the vehicle 101 may receive the high-frequency left turning signal and then send a left turning signal to the key controller 201 of the vehicle 101 after demodulating the high-frequency left turning signal. The key controller 201 authenticates the left turning signal, and then sends out a “left turn” message to cause a steering wheel of the vehicle 101 to turn left. The user may release the left turning key 603 to cause the vehicle to stop turning left.

In one embodiment of the present disclosure, when the driver activates the right turning key 604 by, for example, pressing and holding the right turning key 604, the vehicle intelligent key device 102 may modulate relevant information and send a high-frequency right turning signal. Then the high-frequency receiving device 103 of the vehicle 101 may receive the high-frequency right turning signal and send a right turning signal to the key controller 201 of the vehicle 101 after demodulating the high-frequency right turning signal. The key controller 201 authenticates the right turning signal, and then sends out a “right turn” message to cause the steering wheel of the vehicle to turn right. The user may release the right turning key 604 to cause the vehicle to stop turning right.

The direction control key 502 may be effective only when the starting key 501 is activated to start the remote control mode. Additionally, the left turning key 603, the right turning key 604, the forward key 601, and the backward key 602 may not be effective at the same time. For example, the driver may not be able to control the vehicle 101 to turn left or right when controlling the vehicle 101 to move forward or reverse through the forward key 601 or the backward key 602. Thus, it is ineffective to press down the left turning key 603 or the right turning key 604 during the forward or backward motion of the vehicle 101. Similarly, the driver may not be able to control the vehicle 101 to move forward or backward when controlling the vehicle to turn left or right through the left turning key 603 or the right turning key 604. Thus, it is ineffective to press down the forward key 601 or the backward key 602 during the left or right turning of the vehicle 101.

Referring to FIG. 6, the vehicle intelligent key device 102 according to embodiments of the present disclosure may further comprise a locking key 607, an unlocking key 608, a trunk opening key 609, and a holding key 605, electronically connected to the control module 504, respectively.

The control module 504 is configured to control the wireless communication module 503 to send a locking signal to the vehicle 101 when the locking key 607 is activated. In other words, when the locking key 607 is activated by the user, the vehicle intelligent key device 102 may modulate relevant information and send a high-frequency locking signal. The high-frequency receiving device 103 of the vehicle 101 may receive the high-frequency locking signal and send the locking signal to the key controller 201 of the vehicle 101 after demodulating the high-frequency locking signal. The key controller 201 authenticates the locking signal, and sends out a “remote locking” message. Thus, the vehicle 101 can be locked according to the “remote locking” message so as to avoid mis-operation.

The control module 504 is configured to control the wireless communication module 503 to send an unlocking signal to the vehicle 101 when the unlocking key 608 is activated. In other words, when the unlocking key 608 is activated by the user, the vehicle intelligent key device 102 may modulate relevant information and send a high-frequency unlocking signal. Then the high-frequency receiving device 103 of the vehicle 101 may receive the high-frequency unlocking signal and send the unlocking signal to the key controller 201 of the vehicle 101 after demodulating the high-frequency unlocking signal. The key controller 201 authenticates the unlocking signal, and sends out a “remote unlocking” message. Thus, the activating the unlocking key 608 may unlock the vehicle 101 during the remote operation, causing the vehicle 101 to quit the remote control mode.

The control module 504 is configured to control the wireless communication module 503 to send a trunk opening signal to the vehicle 101 when the trunk opening key 609 is activated. In other words, when the trunk opening key 609 is activated by the user, the vehicle intelligent key device 102 may modulate relevant information and send a high-frequency trunk opening signal. Then the high-frequency receiving device 103 of the vehicle 101 may receive the high frequency trunk opening signal and send the trunk opening signal to the key controller 201 of the vehicle 101 after demodulating the high-frequency trunk opening signal. The key controller 201 authenticates the signal, and sends out a “remote trunk opening” message, causing a trunk of the vehicle 101 to open.

The control module 504 is configured to lock the keys of the vehicle intelligent key device 102 including the starting key 501, the direction control key 502, the locking key 607, the unlocking key 608, and the trunk opening key 609, when the holding key 605 is activated. In other words, when the holding key 605 is activated by the user, the vehicle intelligent key device 102 may modulate relevant information and send a high-frequency holding signal. Then the high-frequency receiving device 103 of the vehicle 101 may receive the high-frequency holding signal and send the holding signal to the key controller 201 of the vehicle 101 after demodulating the high-frequency holding signal. The key controller 201 authenticates the holding signal, and sends out a “holding” message to control the vehicle 101 not to execute any action according to the signals (e.g., the starting signal or the direction controlling signal) sent from the vehicle intelligent key device 101, when the vehicle is already in a desired condition (e.g., the vehicle is already parked in a given location). Thus, mis-operation may be avoided.

In some embodiments of the present disclosure, the vehicle intelligent key device 102 may further comprise an indicator 606 configured to indicate a status of the vehicle intelligent key device 102. The indicator 606 may have a desired color, such as red, green, yellow, etc. For example, the indicator 606 may be turned on for a fourth predetermined time period whenever the vehicle intelligent key device 102 is activated and sends out a signal.

In one embodiment of the present disclosure, the fourth predetermined time period may be 250 milliseconds. For example, the indicator 606 emits light when the vehicle intelligent key device 102 is activated, indicating that the vehicle intelligent key device 102 operates normally. When the indicator 606 fails to turn on, it indicates that the electrical power of the vehicle intelligent key device 102 is low or the signal is too weak.

In one embodiment of the present disclosure, the vehicle intelligent key device 102 may further comprise a transponder (not shown) configured to communicate with the vehicle 101 when the wireless communication module 503 is interfered by environmental factors, such as noise signals or obstacles. When the electrical power of the vehicle intelligent key device 102 is low, the transponder may also communicate with the vehicle 101.

The vehicle intelligent key device 102 described herein allows a user to control the vehicle 101 to start by activating the starting key 501, to move forward/backward, and turn left/right at a low speed within a visual range (e.g., about 10 meters around the vehicle 101) by activating the direction control key 502. Thus, it is possible to realize various controls for the vehicle by the user outside the vehicle. It is also easy and convenient for the user to park or move the vehicle 101 in a narrow space. The operation of the vehicle intelligent key device 102 is also simple and convenient.

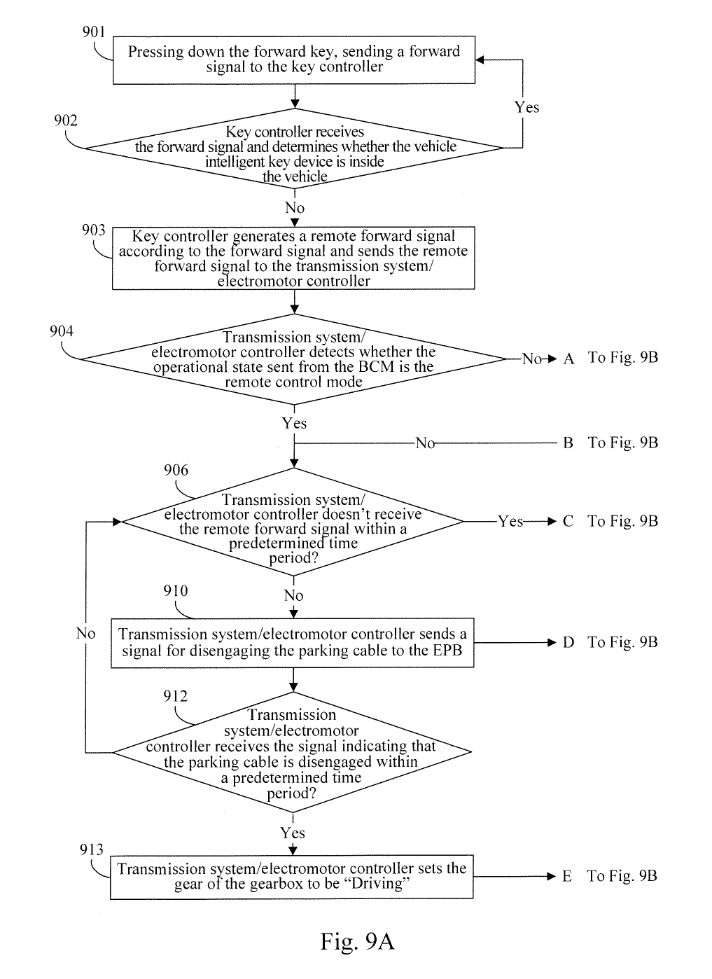

FIGS. 7-13 depict various processes for operating a vehicle by using a vehicle intelligent key device.

FIG. 7 is a flow chart of a remote control method 700 for driving a vehicle according to an embodiment of the present disclosure. As shown in FIG. 7, the remote control method 700 may comprise the following steps.

At step 701, the vehicle intelligent key device generates a starting signal and/or a control signal when the vehicle intelligent key device is activated by the user, and then sends the starting signal and/or the control signal to the vehicle.

At step 702, the vehicle receives the starting signal, and then unlocks and starts a power system and/or an engine of the vehicle. The vehicle may enter a remote control mode according to the starting signal.

At step 703, the vehicle receives the control signal, which controls operational state of the vehicle when the vehicle is in the remote control mode. The controlling of the operational state of the vehicle may comprise controlling a steering system, a speed control system, and a braking system of the vehicle.

At step 704, the power system and/or the engine of the vehicle are controlled to quit the remote control mode when a predetermined condition is satisfied.

In one embodiment of the present disclosure, the starting signal may be a high-frequency starting signal, and the control signal may be a high-frequency control signal.

In one embodiment of the present disclosure, the high-frequency receiving device of the vehicle may receive the high-frequency starting signal and the high-frequency control signal sent from the vehicle intelligent key device, and then send the start signal and the control signal to the key controller of the vehicle after demodulating the high-frequency starting signal and the high-frequency control signal. The key controller generates a remote starting signal and a remote control signal according to the starting signal and the control signal. The remote control signal may be a remote forward signal, a remote backward signal, or a remote turning signal.

In addition, the key controller of the vehicle may detect whether the vehicle intelligent key device is outside the vehicle after receiving the starting signal or the control signal. If yes, the key controller may send the remote starting signal or the remote control signal to a body control module of the vehicle so as to start a remote control mode of the vehicle to control the operational state of the vehicle.

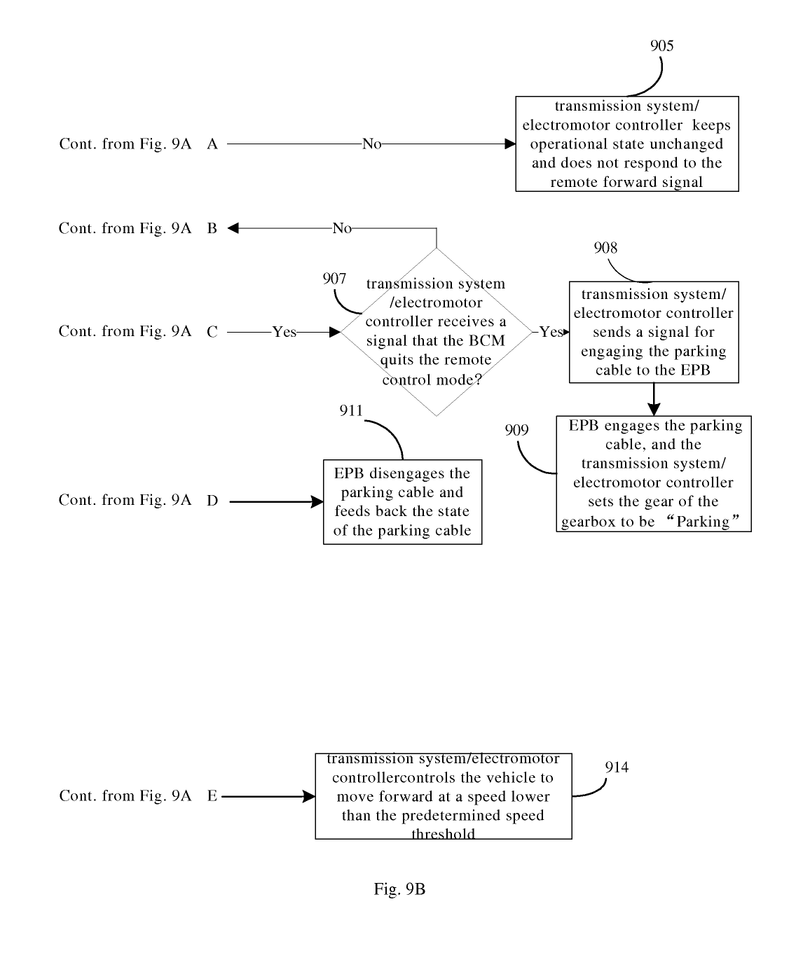

FIGS. 8A and 8B depict a flow chart of a process 800 carried out at step 702 of FIG. 7 for controlling the vehicle to start the remote control mode according to an embodiment of the present disclosure. As shown in FIGS. 8A and 8B, controlling the vehicle to start the remote control mode may comprise the following steps.

At step 801, the starting key of the intelligent key device is pressed down and held for at least the third time period during a fifth time period after the locking key is pressed down. Specifically, the locking key is pressed down by the user so as to keep the vehicle in the locking state. During the fifth time period after the locking key is pressed down, the user may press and hold the starting key for the third time period. Thus, the intelligent key device sends a starting signal to the vehicle. In one embodiment, the third time period may be 2 seconds, the fifth time period may be 5 seconds.

At step 802, the key controller of the vehicle determines whether the starting signal is received and whether the vehicle intelligent key device is inside the vehicle. If yes, the process returns to step 801. If no, the process executes step 803.

At step 803, the key controller generates a remote starting signal according to the starting signal and sends the remote starting signal to the body control module.

At step 804, the body control module receives the remote starting signal sent from the key controller and detects that all of the vehicle doors, the front hatch, and the trunk are locked. The vehicle is armed with an anti-theft system.

At step 805, the body control module sends an unlocking signal to an electric steering column lock. If the unlocking fails, the process executes step 806. If the unlocking is successful, the process executes step 807.

At step 806, the body control module controls the indicator of the starting key to blink and controls an alarm apparatus to buzz. For example, the body control module returns a failed unlocking signal to the vehicle intelligent key device and causes an orange indicator of the starting key to blink and the alarm apparatus to buzz.

At step 807, the body control module sets the power mode to “ON,” and sends out a pairing operation signal to the engine control module. For a fuel vehicle, the body control module also actuates one or more relays, such as an ACC relay, an IG1 relay, and/or an IG2 relay as known in the art.

At step 808, the body control module detects whether a “Park” signal sent from the gearshift and a “normal” signal sent from the electrical parking brake (EPB) are received within a sixth predetermined time period from the time when the relays are actuated. If yes, the process 800 executes step 809. If no, the process 800 executes step 810. In one embodiment, the sixth time period may be 1 second.

At step 809, the engine control module is paired with the key controller. If the engine control module and the key controller are paired successfully, the anti-theft system is disarmed. The engine control module sends out a signal to permit starting of the vehicle. The process 800 then executes step 811. For an electric vehicle, when the pairing operation is successful, the power system of the vehicle is unlocked.

If the anti-theft system is not disarmed within a seventh predetermined time period (e.g., 2 seconds from the time when the pairing operation signal is sent out) and the engine control module does not send out a signal to permit starting of the vehicle, it is indicated that the pairing operation fails. The process 800 then executes step 810.

At step 810, the body control module disconnects the ACC relay, the IG1 relay, and the IG2 relay, and sets the power mode to “OFF.”

At step 811, the body control module actuates an engine relay. The engine control module controls the engine (for the fuel vehicle) to ignite and start. If the engine fails to start, the process 800 executes step 810 Otherwise, the process 800 executes step 812. For the electric vehicle, the electromotor controller controls the vehicle to start.

At step 812, the body control module sets the power mode to “START” and sends out a remote control mode signal.

At step 813, the transmission system (for the fuel vehicle) or the electromotor controller (for the electric vehicle) enters a remote control mode.

At step 814, the body control module detects whether the remote control mode signal returned by the transmission system (for the fuel vehicle) or the electromotor controller (for the electric vehicle) is received within a predetermined time period (e.g., 2 seconds). If yes, the process 800 returns to step 812. If not, the process 800 then executes step 815.

At step 815, the body control module quits the remote control mode, loses communication with the transmission system (for the fuel vehicle) or the electromotor controller (for the electric vehicle), and records the communication failure.

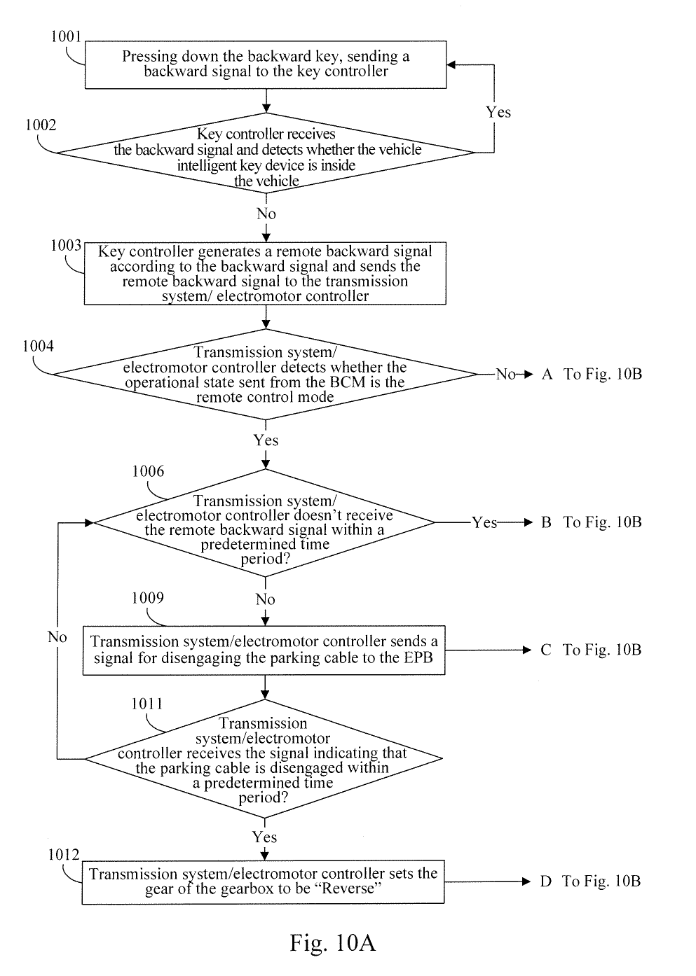

FIGS. 9A and 9B show a flow chart of a process 900 for controlling the vehicle to move forward according to an embodiment of the present disclosure. As shown in FIGS. 9A and 9B, after the vehicle enters the remote control mode, controlling the vehicle to move forward may comprise the following steps.

At step 901, the forward key of the vehicle intelligent key device is pressed down and held, and a forward signal is sent to the key controller of the vehicle.

At step 902, the key controller receives the forward signal and determines whether the vehicle intelligent key device is inside the vehicle. If yes, the process 900 returns to step 901. If no, the process 900 then then executes step 903.

At step 903, the key controller generates a remote forward signal according to the forward signal and sends the remote forward signal to the transmission system (for the fuel vehicle) or the electromotor controller (for the electric vehicle).

At step 904, the transmission system (for the fuel vehicle) or the electromotor controller (for the electric vehicle) detects whether operational state sent from the body control module indicates the remote control mode. If yes, the process 900 executes step 906. If no, the process 900 then executes step 905.

At step 905, the transmission system (for the fuel vehicle) or the electromotor controller (for the electric vehicle) keeps the operational state unchanged and does not response to the remote forward signal.

At step 906, it is detected whether the transmission system (for the fuel vehicle) or the electromotor controller (for the electric vehicle) receive the remote forward signal sent from the key controller within a predetermined time period (e.g., 100 ms). If no, the process 900 then executes step 907. If yes, the process 900 then executes step 910.

At step 907, it is detected whether the transmission system (for the fuel vehicle) or the electromotor controller (for the electric vehicle) detects a signal that the body control module quits the remote control mode. If yes, the process 900 then executes step 908. If no, the process 900 then returns to step 906.

At step 908, the transmission system (for the fuel vehicle) or the electromotor controller (for the electric vehicle) sends a signal for engaging the parking cable to apply the electrical parking brake.

At step 909, the electrical parking brake engages the parking cable, and the transmission system (for the fuel vehicle) or the electromotor controller (for the electric vehicle) sets the gearbox to the “Park” gear.

At step 910, the transmission system (for the fuel vehicle) or the electromotor controller (for the electric vehicle) sends a signal for disengaging the parking cable to the electrical parking brake.

At step 911, the electrical parking brake disengages the parking cable and returns the state of the parking cable.

At step 912, it is detected whether the transmission system (for the fuel vehicle) or the electromotor controller (for the electric vehicle) receives the signal indicating that the parking cable is disengaged within a predetermined time period, such as 2 seconds. If yes, the process 900 then executes step 913. If no, the process 900 returns to step 906.

At step 913, the transmission system (for fuel vehicle) or electromotor controller (for electric vehicle) sets the gear of the gearbox to “Drive.”

At step 914, the transmission system (for the fuel vehicle) or the electromotor controller (for the electric vehicle) controls the vehicle to move forward at a speed lower than the predetermined threshold speed (e.g., 2 km/h).

Thus, when a user presses down and holds the forward key of the vehicle intelligent key device, the gearbox changes to the “Drive” gear. The parking cable of the electrical parking brake is disengaged. The vehicle moves forward. If the user releases the forward key, the parking cable of the electrical parking brake is engaged. The gearbox is set to the “Park” gear. The vehicle stops moving.

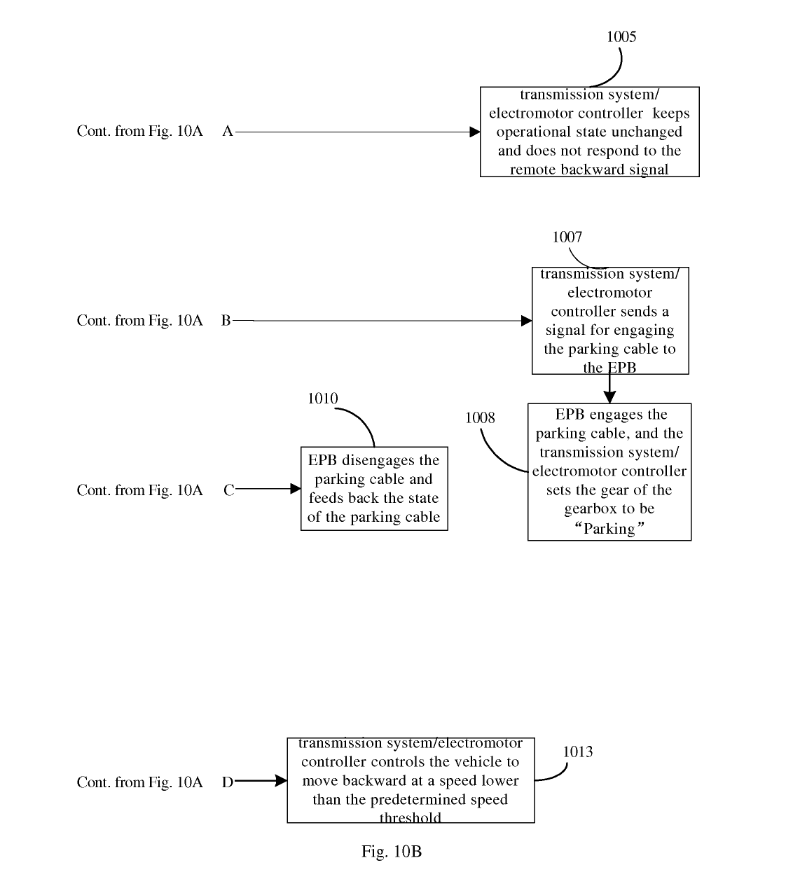

FIGS. 10A and 10B is a flow chart of a process 1000 for controlling the vehicle to reverse according to an embodiment of the present disclosure. As shown in FIGS. 10A and 10B, after the vehicle enters the remote control mode, controlling the vehicle to reverse may comprise the following steps.

At step 1001, the backward key of the vehicle intelligent key device is pressed down and held, and a backward signal is sent to the key controller of the vehicle.

At step 1002, the key controller determines whether the backward signal is received and whether the vehicle intelligent key device is inside the vehicle. If yes, the process 1000 returns to step 1001. If no, the process 1000 then executes step 1003.

At step 1003, the key controller generates a remote backward signal according to the backward signal and sends the remote backward signal to the transmission system (for the fuel vehicle) or the electromotor controller (for the electric vehicle).

At step 1004, the transmission system (for the fuel vehicle) or the electromotor controller (for the electric vehicle) detects whether an operational state sent from the body control module indicates the remote control mode. If yes, the process 1000 executes step 1006. If no, the process 1000 then executes step 1005.

At step 1005, the transmission system (for the fuel vehicle) or the electromotor controller (for the electric vehicle) keeps the operational state unchanged and does not respond to the remote backward signal.

At step 1006, it is detected whether the transmission system (for the fuel vehicle) or the electromotor controller (for the electric vehicle) receives the remote backward signal sent from the key controller within a predetermined time period (e.g., 100 ms). If no, the process 1000 executes step 1007. If yes, the process 1000 then executes step 1009.

At step 1007, the transmission system (for the fuel vehicle) or the electromotor controller (for the electric vehicle) sends a signal for engaging the parking cable to apply the electrical parking brake.

At step 1008, the electrical parking brake engages the parking cable, and the transmission system (for the fuel vehicle) or the electromotor controller (for the electric vehicle) sets the gearbox to the “Park” gear.

At step 1009, the transmission system (for the fuel vehicle) or the electromotor controller (for the electric vehicle) sends a signal for disengaging the parking cable of the electrical parking brake.

At step 1010, the electrical parking brake disengages the parking cable and returns the state of the parking cable.

At step 1011, it is detected whether the transmission system (for the fuel vehicle) or the electromotor controller (for the electric vehicle) receives the signal indicating that the parking cable is disengaged within a predetermined time period, such as 2 seconds. If yes, the process 1000 executes step 1012. If no, the process 1000 returns to step 1006.

At step 1012, the transmission system (for the fuel vehicle) or the electromotor controller (for the electric vehicle) sets the gearbox to the “Reverse” gear.

At step 1013, the transmission system (for the fuel vehicle) or the electromotor controller (for the electric vehicle) controls the vehicle to reverse at a speed lower than the predetermined threshold speed (e.g., 2 km/h).

Thus, when a user presses down and holds the backward key, the gearbox is switched to the “Reverse” gear, the parking cable of the electrical parking brake is disengaged, and the vehicle moves backward. If the user releases the backward key, the parking cable of the electrical parking brake is engaged. The gearbox is set to the “Park” gear. The vehicle stops moving.

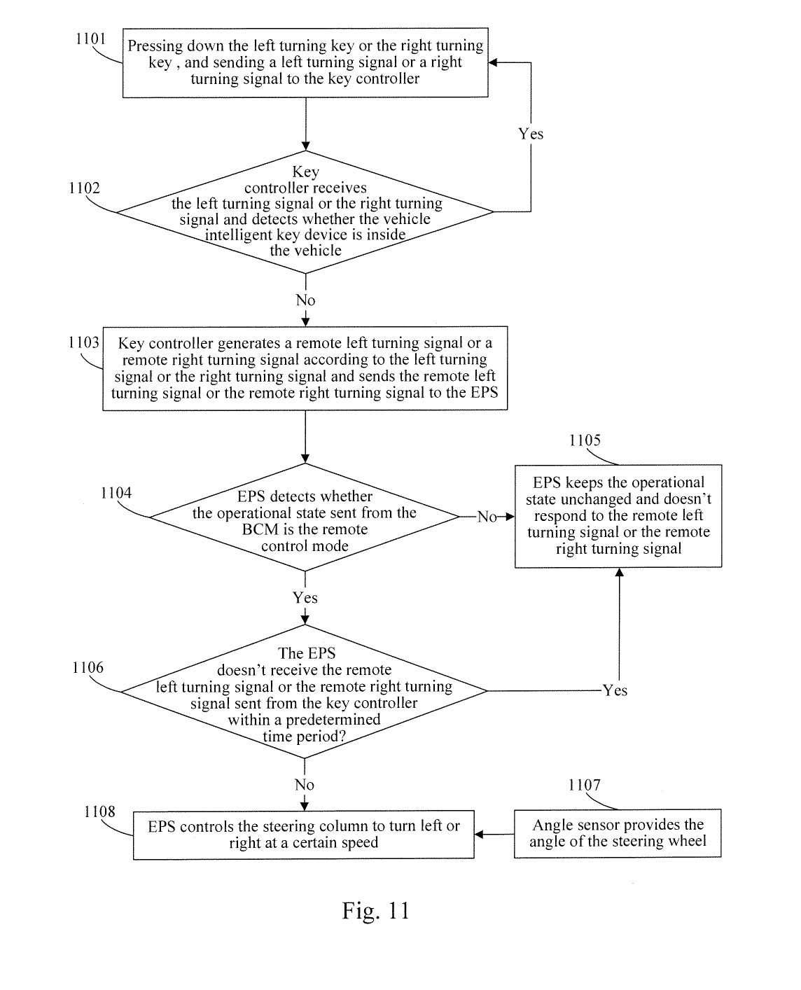

FIG. 11 is a flow chart of a process 1100 for controlling the vehicle to turn left or right according to an embodiment of the present disclosure. As shown in FIG. 11, after the vehicle enters the remote control mode, controlling the vehicle to turn left or right may comprise the following steps.

At step 1101, the left turning key of the vehicle intelligent key device or the right turning key of the vehicle intelligent key device is pressed down and held, and a left turning signal or a right turning signal is sent to the key controller of the vehicle.

At step 1102, the key controller determines whether the left turning signal or the right turning signal is received and whether the vehicle intelligent key device is inside the vehicle. If yes, the process 1100 returns to step 1101. If no, the process 1100 then executes step 1103.

At step 1103, the key controller generates a remote left turning signal or a remote right turning signal according to the left turning signal or the right turning signal and sends the remote left turning signal or the remote right turning signal to the electric power steering module.

At step 1104, the electric power steering module detects whether the operational state sent from the body control module indicates the remote control mode. If yes, the process 1100 executes step 1106. If no, the process 1100 then executes step 1105.

At step 1105, the electric power steering module keeps the operational state of the vehicle unchanged and does not respond to the remote left turning signal or the remote right turning signal.

At step 1106, it is detected whether the electric power steering module receives the remote left turning signal or the remote right turning signal sent from the key controller within a predetermined time period (e.g., 100 ms). If no, the process 1100 executes step 1105. If yes, the process 1100 then executes step 1108.

At step 1107, the angle sensor detects the rotation angle of the steering wheel and provides the rotation angle to the electric power steering module.

At step 1108, the electric power steering module controls the steering column to turn left or right at a certain speed based on the rotational angle provided by the angle sensor.

Thus, when a user presses down and holds the left turning key, the electric power steering module controls the steering wheel to turn left. If the user releases the left turning key, the steering wheel stops turning left. When a user presses down and holds the right turning key, the electric power steering module controls the steering wheel to turn right. If the user releases the right turning key, the steering wheel stops turning right.

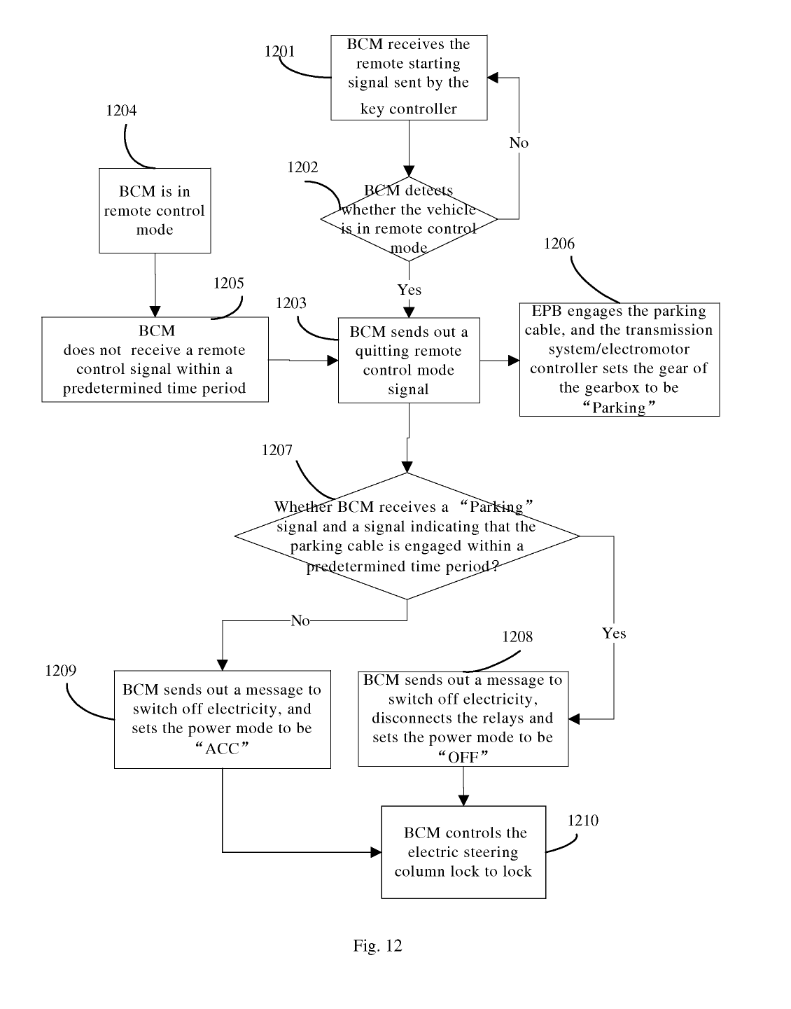

FIG. 12 is a flow chart of a process 1200 for controlling the vehicle to quit the remote control mode according to an embodiment of the present disclosure. As shown in FIG. 12, controlling the vehicle to quit the remote control mode may comprise the following steps.

At step 1201, the body control module receives the remote starting signal sent from the key controller indicating the starting key 501 is shortly pressed down.

At step 1202, the body control module detects whether the vehicle is in the remote control mode. If yes, the process 1200 executes step 1203. If no, the process 1200 then returns to step 1201.

At step 1203, the body control module sends out a quit remote control mode signal.

Consistent with embodiments of the present disclosure, other scenarios may also trigger the execution of step 1203. For example, as shown in FIG. 12, at step 1204, the vehicle 101 is already in the remote control mode.

At step 1205, it is detected that the body control module does not receive a remote forward signal, a remote backward signal, or a remote turning signal within a predetermined time period (for example, 10 minutes). As a result, the process proceeds to step 1203.

At step 1206, the EPB engages the parking cable, and the DCT (for a fuel vehicle)/the electromotor controller (for an electric vehicle) sets the gear of the gearbox to “Park”.

At step 1207, it is detected whether the body control module receives a “Parking” signal and a signal indicating that the parking cable is engaged within a predetermined time period (for example, 2 seconds). If yes, goes to step 1208, if no, goes to step 1209.

At step 1208, the body control module sends out a message to turn off electricity, disconnects the ACC relay, the IG1 relay, and the IG3 relay, and sets the power mode to “OFF.”

At step 1209, the body control module sends out a message to turn off electricity, and sets the power mode to “ACC”.

At step 1210, the body control module controls the electric steering column lock to lock.

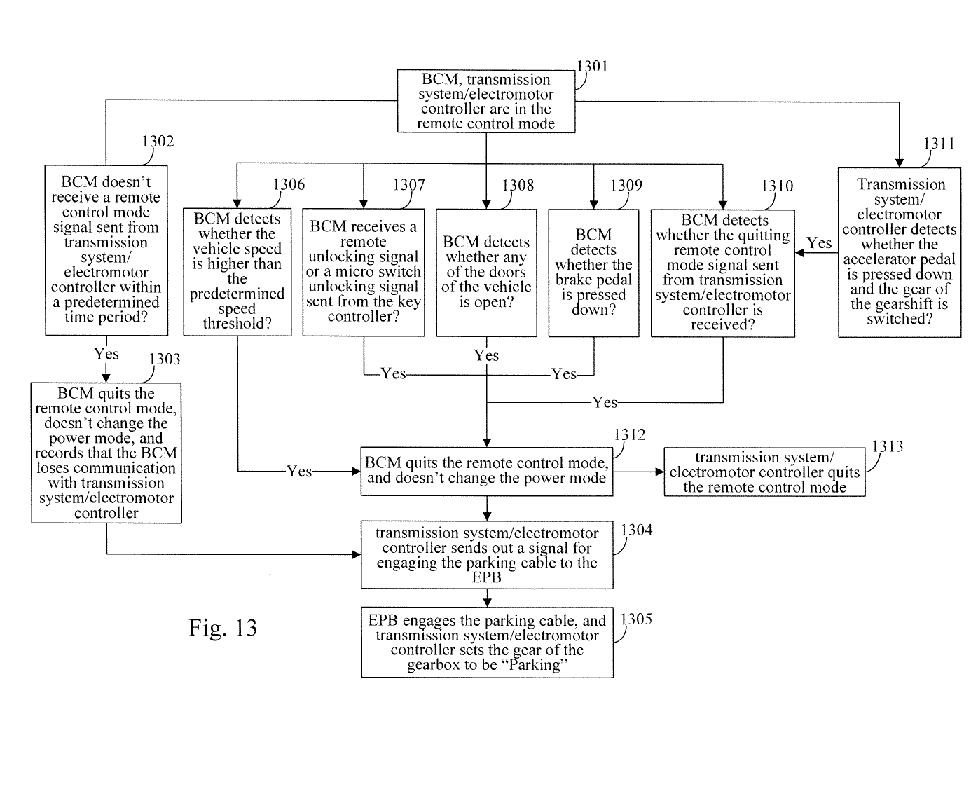

FIG. 13 is a flow chart of a process 1300 for controlling the vehicle to quit the remote control mode according to another embodiment of the present disclosure. As shown in FIG. 13, controlling the vehicle to quit the remote control mode may comprise the following steps

At step 1301, the body control module, the transmission system (for the fuel vehicle), and the electromotor controller (for the electric vehicle) are in the remote control mode.

At step 1302, it is detected whether the body control module receives a remote control mode signal sent from the transmission system (for the fuel vehicle) or the electromotor controller (for the electric vehicle) within a predetermined time period (e.g., 2 seconds). If yes, the process 1300 executes step 1309.

At step 1309, the body control module quits the remote control mode (under normal driving mode), maintains the power mode, and records that the body control module loses communications with the transmission system (for the fuel vehicle) or the electromotor controller (for the electric vehicle). The process 1300 then executes step 1312.

At step 1303, the body control module detects whether the vehicle speed is higher than the predetermined vehicle speed threshold (e.g., 2 km/h) If yes, the process 1300 executes step 1310. Alternatively, the process 1300 may determine whether the speed signal is detected at step 1303. If no, the process 1300 also executes step 1310.

At step 1304, it is detected whether the body control module receives a remote unlocking signal or a micro switch unlocking signal sent from the key controller. If yes, the process 1300 executes step 1310.

At step 1305, the body control module detects whether any doors of the vehicle is open. If yes, the process 1300 executes step 1310.

At step 1306, the body control module detects whether a brake pedal is pressed down. If yes, the process 1300 executes step 1310.

At step 1307, the body control module detects whether a quitting remote control mode signal sent from the transmission system (for the fuel vehicle) or the electromotor controller (for the electric vehicle) is received. If yes, the process 1300 executes step 1310.

At step 1308, the transmission system (for the fuel vehicle) or the electromotor controller (for the electric vehicle) detects whether an accelerator pedal is pressed down, and the gear of the gearbox is shifted. If yes, the process 1300 executes step 1307.

At step 1310, the body control module the body control module quits the remote control mode (under normal driving mode), and maintains the power mode.

At step 1311, the transmission system (for the fuel vehicle) or the electromotor controller (for the electric vehicle) quits the remote control mode.

At step 1312, the transmission system (for fuel vehicle) or the electromotor controller (for electric vehicle) sends out a signal for engaging the parking cable.

At step 1313, the electrical parking brake engages the parking cable. The transmission system (for the fuel vehicle) or the electromotor controller (for the electric vehicle) sets the gearbox to the “Park” gear.

It should be noted that the steps 1302-1308 may be executed simultaneously or sequentially in an order as desired. Furthermore, when at least one of the conditions described in these steps is satisfied, the vehicle quits the remote control mode. Thus, the other steps may not be executed.

Thus, the vehicle quits the remote control mode if any one of the following conditions is satisfied:

(1) No remote controlling operation is implemented over a predetermined time period (e.g., 10 minutes). Thus, the parking cable of the electrical parking brake is engaged. The gearbox is set to the “Park” gear. The vehicle stops. The engine is turned off. The electric steering column lock is engaged.

(2) The starting key is pressed down for a short period of time. Similarly, the parking cable of the electrical parking brake is engaged. The gearbox is set to the “Park” gear. The vehicle stops. The engine is turned off. The electric steering column lock is engaged.

(3) The vehicle intelligent key device is unlocked or a micro switch is unlocked to open a door of the vehicle. Thus, the parking cable of the electrical parking brake is engaged. The gearbox is set to the “Park” gear. The vehicle stops. But the engine is not turned off.

(4) An accelerator pedal or a brake pedal is pressed down. Thus, the gear of a gear lever is changed to quit the remote control mode. But the engine is not turned off.

(5) The vehicle speed is higher than the predetermined threshold speed, such as 2 km/h, or a vehicle speed signal is faulty. Thus, the vehicle quits the remote control mode, but the engine is not turned off.

It is advantageous for quitting the remote control mode when the vehicle in the remote control mode is driven by the user, the user forgets to turn off the engine, causing the vehicle remains in the remote control mode for a long time, or the vehicle loses the remote control function due to failure of the direction control key.

The system and method disclosed herein allow a user to control the vehicle to start, move forward or reverse, and turn left or right within a visual range (e.g., 10 meters) outside the vehicle. The control operation is simple. Therefore, it is convenient for the user to park or move the vehicle in a narrow space. In addition, the user may control the vehicle to quit the remote control mode as desired, and thus ensure safety.

Reference throughout this specification to “an embodiment,” “some embodiments,” “one embodiment”, or “embodiments,” means that a particular feature, structure, material, or characteristic described in connection with the embodiment or example is included in at least one embodiment or example of the present disclosure. Thus, the appearances of the phrases such as “in some embodiments,” “in one embodiment,” “in embodiments,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

What is claimed is:

1. A remote control system for driving a passenger vehicle, comprising:
a vehicle intelligent key device configured to send a starting signal and a control signal;
a passenger vehicle configured to receive the starting signal and the control signal, to start a remote control mode according to the starting signal and to control an operational state of the passenger vehicle according to the control signal, and to quit the remote control mode when a predetermined condition is satisfied.

2. The remote control system according to claim 1, wherein the passenger vehicle comprises:
a key controller, configured to receive the starting signal and the control signal and to generate a remote starting signal and a remote control signal according to the starting signal and the control signal, respectively;
a body control module, configured to receive the remote starting signal and the remote control signal, to control the passenger vehicle to power on and to start the remote control mode according to the remote starting signal and to generate an unlocking signal;
an electric steering column lock, configured to receive the unlocking signal sent from the body control module and to unlock a steering wheel of the passenger vehicle according to the unlocking signal;
a gateway, configured to communicate with the key controller, the body control module and the electric steering column lock;
an engine control module, configured to communicate with the gateway and to control an engine of the passenger vehicle to start according to the remote starting signal transmitted by the gateway;
an automatic transmission, configured to communicate with the gateway, and to control a gear of a gearbox of the passenger vehicle to switch and to generate a parking control signal according to the remote control signal transmitted by the gateway; and
an electrical parking brake, configured to communicate with the gateway and to control the passenger vehicle to park according to the parking control signal transmitted by the gateway.

3. The remote control system according to claim 2, wherein the automatic transmission includes a dual clutch transmission.

4. The remote control system according to claim 2, wherein the predetermined condition comprises any one of:
no remote control signal is detected by the body control module during a first predetermined time period;
no remote control mode signal indicating the passenger vehicle is in the remote control mode is detected by the body control module during a second predetermined time period;
a quitting remote control mode signal is detected by the body control module;
a vehicle door is detected to be open by the body control module;
a brake pedal or an accelerator pedal is detected to be pressed down by the body control module;
a vehicle speed is detected to be higher than a predetermined vehicle speed threshold or the vehicle speed is not detected by the body control module; and
a remote unlocking signal or a micro switch unlocking signal sent by the key controller is received by the body control module.

5. The remote control system according to claim 2, wherein the starting signal includes a high-frequency starting signal and the control signal includes a high-frequency control signal.

6. The remote control system according to claim 5, wherein the passenger vehicle further comprises a receiving device configured to receive the high-frequency starting signal and the high-frequency control signal, to demodulate the high-frequency starting signal and the high-frequency control signal so as to obtain the starting signal and the control signal, and to send the starting signal and the control signal to the key controller.

7. The remote control system according to claim 2, wherein the key controller is further configured to detect whether the vehicle intelligent key device is outside the passenger vehicle after receiving the starting signal and the control signal, and to send the remote starting signal and the remote control signal to the body control module when the vehicle intelligent key device is outside the passenger vehicle.

8. The remote control system according to claim 2, wherein the body control module is further configured to detect a state of the electrical parking brake and a gear of a gearbox of the passenger vehicle.

9. The remote control system according to claim 8, wherein when the state of the electrical parking brake is “normal” and the gear of the gearbox of the passenger vehicle is “Park,” the engine control module and the key controller perform a pairing operation and if the engine control module and the key controller are paired, the engine control module controls the engine to start.

10. The remote control system according to claim 8, wherein the automatic transmission is configured to send an engaging signal for engaging a parking cable of the electrical parking brake and to set the gearbox to a “Park” state when the passenger vehicle quits the remote control mode.

11. A passenger vehicle intelligent key device, comprising:
a starting key;
a direction control key;
a wireless communication module, configured to communicate with a passenger vehicle wirelessly; and
a controlling module, connected to the starting key, the direction control key and the wireless communication module and configured to send a starting signal or a control signal to the passenger vehicle when the starting key or the direction control key is activated.

12. The passenger vehicle intelligent key device according to claim 11, wherein the direction control key comprises at least one of a left turning key, a right turning key, a forward key, and a backward key.

13. The passenger vehicle intelligent key device according to claim 11, further comprising a locking key and an unlocking key electronically connected to the control module,
wherein the control module is configured to control the wireless communication module to send a locking signal to the passenger vehicle when the locking key is activated and to send an unlocking signal to the passenger vehicle when the unlocking key is activated.

14. The passenger vehicle intelligent key device according to claim 11, further comprising a transponder configured to communicate with the passenger vehicle.

15. A remote control method for driving a passenger vehicle, comprising:
generating a starting signal and a control signal by a vehicle intelligent key device;
sending the starting signal and the control signal to a passenger vehicle;
starting a remote control mode of the passenger vehicle according to the starting signal;
controlling operational state of the passenger vehicle according to the control signal; and
quitting the remote control mode when a predetermined condition is satisfied.

16. The remote control method according to claim 15, wherein the predetermined condition comprises any one of:
no remote control signal is detected by a body control module during a first predetermined time period;
no remote control mode signal indicating that the passenger vehicle is in the remote control mode is detected by the body control module during a second predetermined time period;
a quitting remote control mode signal is detected by the body control module;
a vehicle door is detected to be open by the body control module;
a brake pedal or an accelerator pedal is detected to be pressed down by the body control module;
a vehicle speed is detected to be higher than a predetermined threshold speed or the vehicle speed is not detected by the body control module;
a remote unlocking signal or a micro switch unlocking signal sent from the key controller is received by the body control module.

17. The remote control method according to claim 15, further comprising:
sending an engaging signal for engaging a parking cable of an electrical parking brake; and
setting a gearbox to a “Park” state when quitting the remote control mode.

18. The remote control method according to claim 15, wherein the starting signal includes a high-frequency starting signal and the control signal includes a high-frequency control signal.

19. The remote control method according to claim 18, further comprising:
receiving the high-frequency starting signal and the high-frequency control signal from the vehicle intelligent key device by a high-frequency receiving device of the passenger vehicle;
demodulating the high-frequency starting signal and the high-frequency control signal by the high-frequency receiving device so as to obtain the starting signal and the control signal;
sending the starting signal and the control signal from the high-frequency receiving device to the key controller; and
generating a remote starting signal and a remote control signal according to the starting signal and the control signal by the key controller.

20. The remote control method according to claim 19, further comprising:
detecting whether the vehicle intelligent key device is outside the passenger vehicle after the key controller receives the starting signal or the control signal; and
if the vehicle intelligent key device is outside the passenger vehicle after the key controller receives the starting signal or the control signal, sending the remote starting signal or the remote control signal to a body control module of the passenger vehicle.
